(19) United States
(12) Patent Application Publication
(10) Pub. No.: US 2013/0285393 A1
(43) Pub. Date: Oct. 31, 2013

(54) Electronic Controlled Handles

(71) Applicant: TriTeq Lock and Security LLC, Eik Grove Village, IL (US)

(72) Inventors: Calin Roatis, Long Grove, IL (US); Gabriel Ribu, Niles, IL (US); William Denison, North Barrington, IL (US)

(21) Appl. No.: 13/866,525

(22) Filed: Apr. 19, 2013

Related U.S. Application Data
(60) Provisional application No. 61/636,263, filed on Apr. 20, 2012.

(51) Int. Cl. E05B 1/00

(52) U.S. Cl. CPC E05B 1/003
USPC 292/336.3

(57) ABSTRACT

In accordance with an embodiment, electronic control is provided for the locking function of Lift-Handle and T-Handle products, while maintaining desirable mechanical latching mechanism functions and operations.

### CROSS-REFERENCE TO RELATED APPLICATION

This application is a non-provisional application claiming priority under 35 U.S.C. 119(e) to U.S. Provisional Application Ser. No. 61/636,263 filed on Apr. 20, 2012.

### TECHNICAL FIELD OF THE DISCLOSURE

The present disclosure relates to latching and locking handles and, more particularly, relates to electronic control of the locking function of Lift-Handle and T-Handle products.

### BACKGROUND OF THE DISCLOSURE

In the vending industry and other industries where product security and secured access are needed, latching and locking handles are commonly used. Two common configurations are the “Lift-Handle” style and the “T-Handle” style. Both the Lift-Handle and T-Handle products comprise a latch mechanism controlled by the handle for manually latching and unlatching an enclosure such as a vending machine or otherwise. Typically these products are mounted to the door of the enclosure, and interface to a slot or receptacle in a cabinet of the enclosure.

The latching mechanism may be any of a variety of mechanisms, such as a threaded bolt that engages into a receptacle, or one or more latch bars or bolts for extending into the cabinet. In the case of the Lift-Handle style latch, movement of the handle from the seated position to an extended or raised position serves to unlatch the door from the cabinet. In the case of the T-Handle style latch, turning of the handle from the vertical seated position to a horizontal position or unscrewing the threaded latch from the receptacle will serve to unlatch the door from the cabinet.

In addition to the latch mechanism, both the Lift-Handle and T-Handle style closures typically comprise a lock-plug for locking and unlocking the handle from movement. Lock plugs are typically controlled by mechanical keys to allow operation of the handle to access the cabinet. However, it is appreciated in the industry that lock plugs are vulnerable to vandalism and theft. As an additional problem related to such plugs, mechanical keys are subject to being lost, copied and stolen.

One solution to the foregoing problems is to replace the above described Lift-Handle and T-Handle products with motorized latch and lock products. Exemplary replacement products are described, for example, in U.S. Pat. No. 6,581,986 entitled “Bayonet Locking System and Method for Vending Machines and the Like.” However, there is a further need to provide electronic control of the locking function of Lift-Handle and T-Handle products while maintaining the above-described mechanical latching mechanism function/operation to facilitate retrofit of improved closure systems to existing common cabinets in the industry.

### SUMMARY OF THE DISCLOSURE

The present invention will offer electronic control of the locking function of Lift-Handle and T-Handle products, but maintain the above described mechanical latching mechanism function/operation. In accordance with one aspect of the present disclosure, an electronic control lift-handle product is provided having a handle, a housing, a slider bolt, slider bolt pin, slider bolt guide, and one or more springs 4. The product further includes a CAM, motor, circuit board controller, eye, handle sensor, one or more CAM sensors, and an IRDA infrared transceiver. The unit is configured such that the handle seats in the housing when the unit is in the latched or locked position, the motor serves to rotate the CAM by 360 degrees to change the state of handle from locked to unlocked to latched, and the slider bolt seats in the housing and is biased downward to the latched position by the one or more springs, and wherein the CAM maintains the slider bolt in the locked position if there is an attempt to push the slider bolt up to the unlocked position when the unit is locked.

In another embodiment, an electronic control T-handle product is provided having a handle, a housing, latch hardware, a MCU and CPU control electronics. The handle resides inside of the housing, and the MCU is controlled by the CPU to latch, lock and unlock the handle within the housing. The MCU consists of a slider bolt, a spring, a CAM, a motor, a mount, a cover, a handle sensor, and one or more CAM sensors. The handle is locked into the housing by the slider bolt protruding into a handle slot when the unit is latched or locked. The motor serves to rotate the CAM through 360 degrees to change the state of the handle from locked, to unlocked, to latched, and the CAM controls the slider bolt to maintain a locked position if there is an attempt to push the bolt toward the upward unlocked position when the unit is locked.

### BRIEF DESCRIPTION OF THE DRAWINGS

FIG. 1 is a perspective drawing of an aspect of an electronic-control Lift-Handle in accordance with an embodiment of the invention;

FIG. 2 is a perspective drawing of an aspect of an electronic-control Lift-Handle in accordance with an embodiment of the invention;

FIG. 3 is a plan view of an aspect of an electronic-control Lift-Handle in accordance with an embodiment of the invention;

FIG. 4 is a perspective drawing of an aspect of an electronic-control Lift-Handle in accordance with an embodiment of the invention;

FIG. 5 is a plan view drawing of an aspect of an electronic-control Lift-Handle in accordance with an embodiment of the invention;

FIG. 6 is a plan view drawing of an aspect of an electronic-control Lift-Handle in accordance with an embodiment of the invention;

FIG. 7 is a plan view drawing of an aspect of an electronic-control Lift-Handle in accordance with an embodiment of the invention;

FIG. 8 is a plan view drawing of an aspect of an electronic-control Lift-Handle in accordance with an embodiment of the invention;

FIG. 9 is a operational drawing of an aspect of an electronic-control Lift-Handle in accordance with an embodiment of the invention;

FIG. 10 is a flow chart of an aspect of an electronic-control Lift-Handle in accordance with an embodiment of the invention;

FIG. 11 is a flow chart of an aspect of an electronic-control Lift-Handle in accordance with an embodiment of the invention;

FIG. 12 is a flow chart of an aspect of an electronic-control Lift-Handle in accordance with an embodiment of the invention;

FIG. 13 is a perspective drawing of an aspect of an electronic-control T-Handle in accordance with an embodiment of the invention;

FIG. 14 is a perspective drawing of an aspect of an electronic-control T-Handle in accordance with an embodiment of the invention;

FIG. 15 is a perspective drawing of an aspect of an electronic-control T-Handle in accordance with an embodiment of the invention;

FIG. 16a is a plan view drawing of an aspect of an electronic-control T-Handle in accordance with an embodiment of the invention;

FIG. 16b is a plan view drawing of an aspect of an electronic-control T-Handle in accordance with an embodiment of the invention;

FIG. 17 is a operational diagram of an aspect of an electronic-control T-Handle in accordance with an embodiment of the invention;

FIG. 18 is a flow chart of an aspect of an electronic-control T-Handle in accordance with an embodiment of the invention;

FIG. 19 is a flow chart of an aspect of an electronic-control T-Handle in accordance with an embodiment of the invention;

FIG. 20 is a flow chart of an aspect of an electronic-control T-Handle in accordance with an embodiment of the invention;

FIG. 21 is a perspective drawing of an aspect of an electronic-control T-Handle in accordance with an embodiment of the invention;

FIG. 22 is a perspective drawing of an aspect of an electronic-control T-Handle in accordance with an embodiment of the invention;

FIG. 23 is a perspective drawing of an aspect of an electronic-control T-Handle in accordance with an embodiment of the invention;

FIG. 24 is a perspective drawing of an aspect of an electronic-control T-Handle in accordance with an embodiment of the invention;

FIG. 25 is a perspective drawing of an aspect of an electronic-control T-Handle in accordance with an embodiment of the invention;

FIG. 26 is a perspective drawing of an aspect of an electronic-control T-Handle in accordance with an embodiment of the invention;

FIG. 27 is a perspective drawing of an aspect of an electronic-control T-Handle in accordance with an embodiment of the invention;

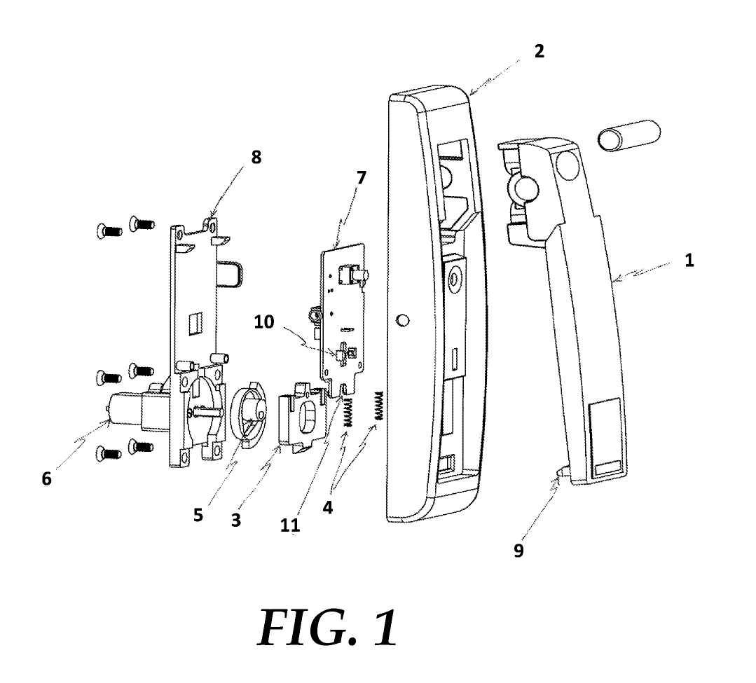

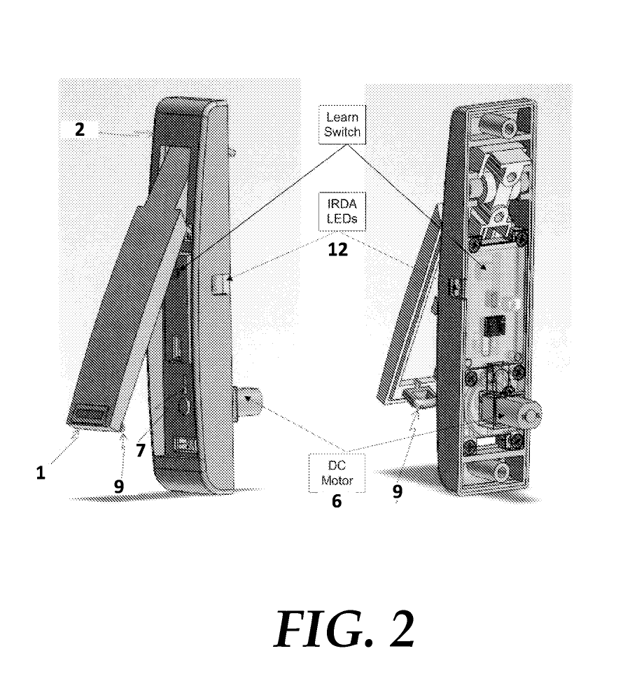

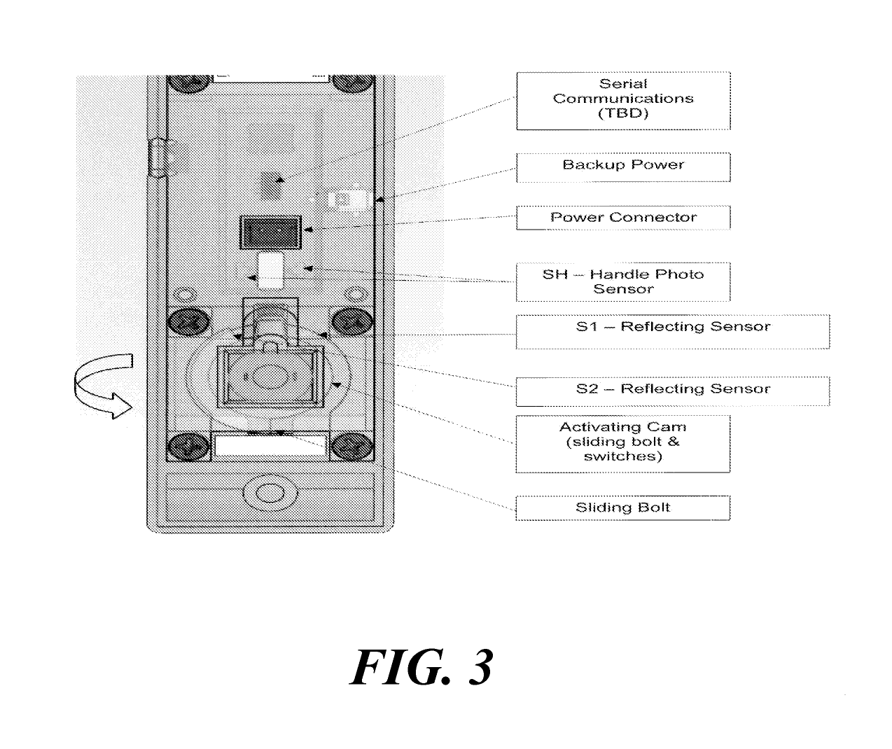

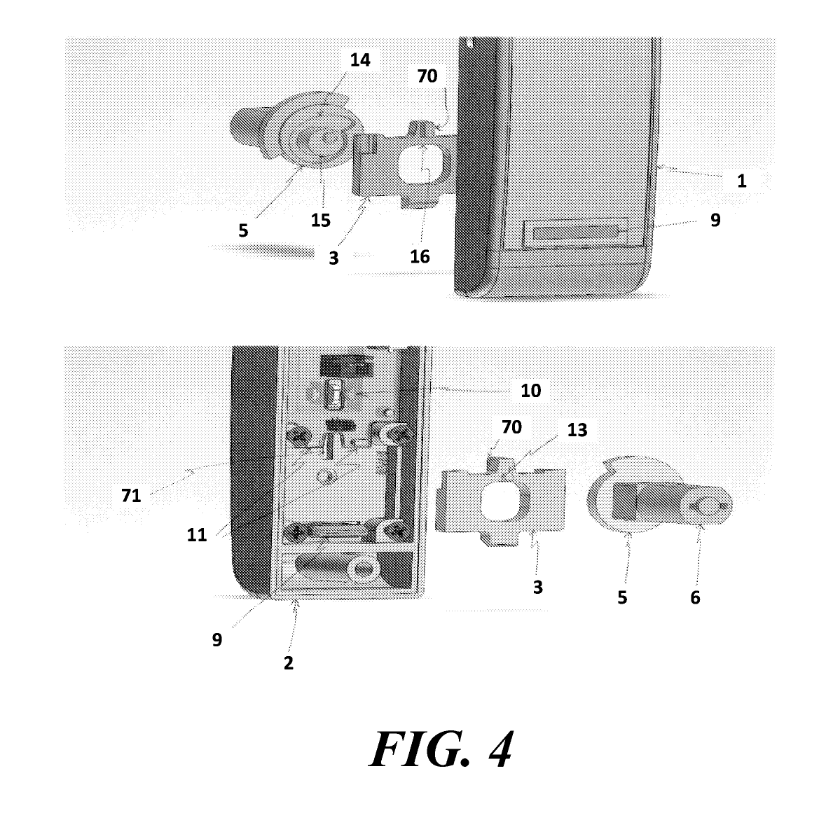

While the present disclosure is susceptible to various modifications and alternative constructions, certain illustrative embodiments thereof will be shown and described below in detail. It should be understood, however, that there is no intention to be limited to the specific embodiments disclosed, but on the contrary, the intention is to cover all modifications, alternative constructions, and equivalents that fall within the spirit and scope of the present disclosure.

### DETAILED DESCRIPTION OF THE DISCLOSURE

While this disclosure describes certain lock structures, it should be appreciated that the electronic lock components described herein are not specific to the Lift-Handle and T-Handle products, but rather can be implemented directly, or modified, to control almost any handle-controlled latch/lock mechanism in the industry. This disclosure will first discuss an exemplary embodiment of a lift handle system, and then will move on to discuss an exemplary embodiment of a T-handle system.

Regarding the Electronic Control Lift-Handle, this product is configured for mounting to the door of a cabinet, and attaches to latch hardware to latch the door to the cabinet. The product consists of a handle 1, housing 2, slider bolt 3, springs 4, CAM 5, motor 6, circuit board controller 7, cover 8, eye 9, handle sensor 10, CAM sensors 11, IRDA infrared transceiver 12, Slider bolt pin 13, Slider bolt guide 70, Housing slot 71.

The handle 1 seats in the housing 2 when the unit is in the latched or locked position. The eye 9 attaches to the handle 1, and is held in place by the slider bolt 3 when the unit is latched or locked. The motor 6 serves to rotate CAM 5 by 360 degrees to change the state of handle 1 from locked to unlocked to latched.

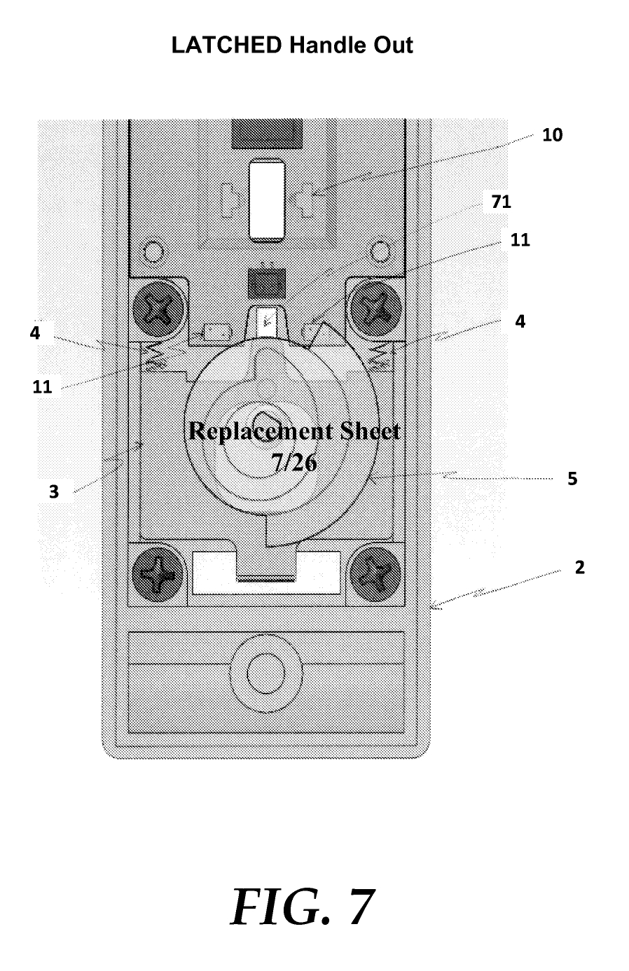

The slider bolt 3 seats in the housing 2 and is biased downward to the latched position (See FIG. 7) by springs 4. The slider bolt guide 70 fits into housing slot 71. The guide 70 is centered on slider bolt 3, and is configured to slide up and down in slot 71 to keep the slider bolt 3 aligned in the housing 2, e.g., to keep it from tilting and from jamming as the slider bolt 3 slides or moves.

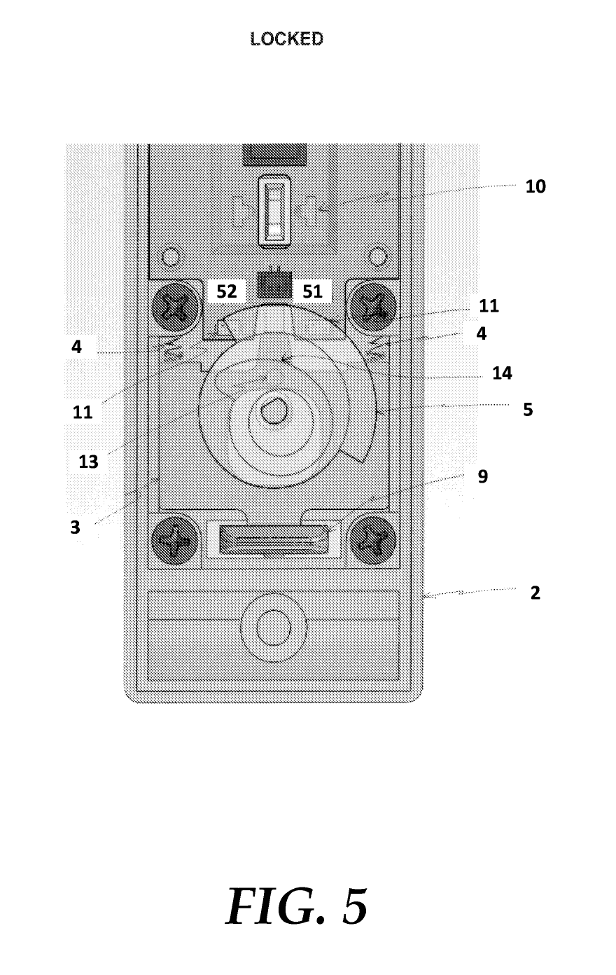

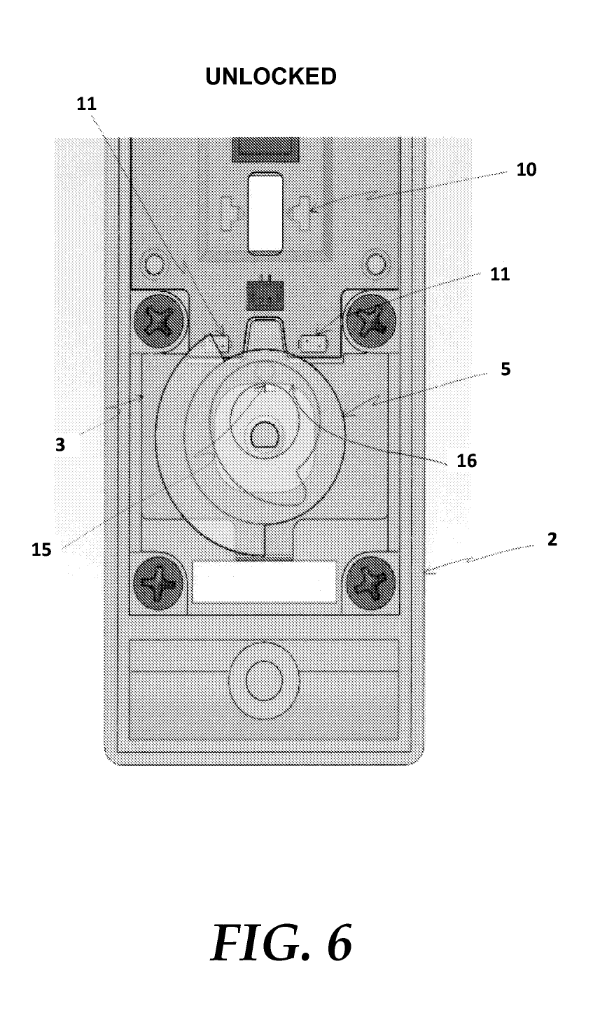

The CAM 5 controls the slider bolt 3 by being capable of keeping the slider bolt 3 in the locked position by surface 14 interfering with slider bolt pin 13 if there is an attempt to push the slider bolt 3 up to the unlocked position when the unit is locked (see FIG. 5). The CAM 5 controls the slider bolt 3 by applying a force from surface 15 to the slider bolt along surface 16 when the motor 6 is rotated and when the unit is unlocked (see FIG. 6).

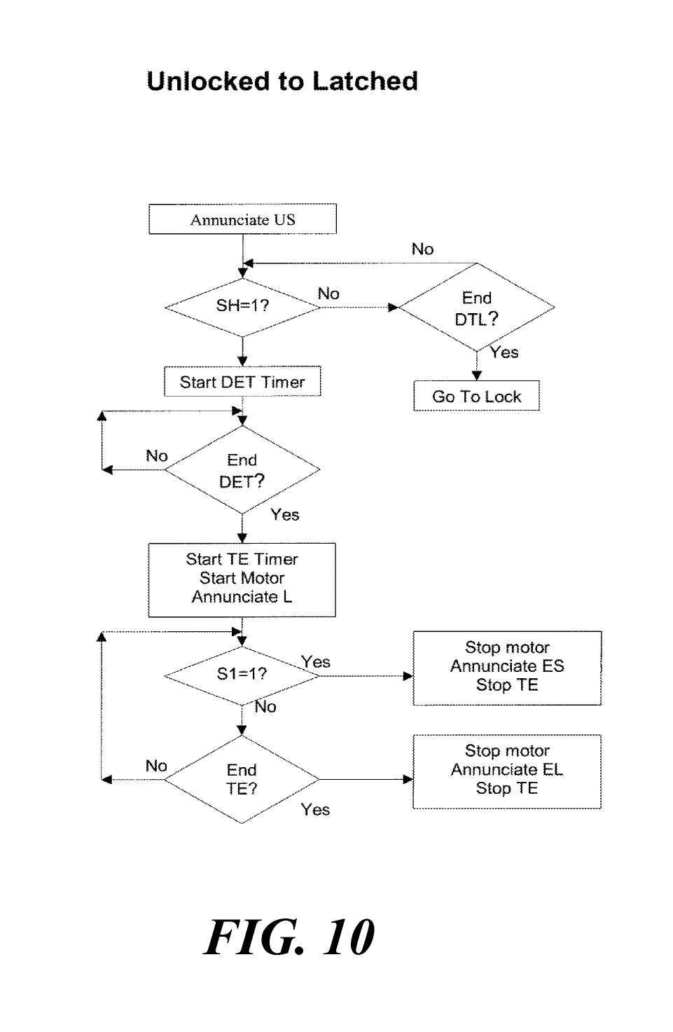

The electronic controller 7 controls the motor 6 to rotate the CAM 5 to the three positions noted above. The position of the CAM 5 is controlled and sensed by two optical sensors 11 sensing the position of CAM 5 in the illustrated example. A handle position sensor 10 is also utilized in an embodiment. An IRDA infrared transceiver 12 is included for detecting an electronic key. The control of the unit is described in the flow charts of FIGS. 10, 11, and 12.

In the flow chart of FIG. 10, the unit is initially locked as in the configuration shown in FIG. 5. If the controller IRDA infrared transceiver 12 detects the electronic key, cam 5 is rotated and applies an upward force to sliding bolt 3 along surface 16 to move the slider bolt 3 against the downward spring bias force and lift bolt 3 to the unlocked position reflected in FIG. 6. Sensors 11 measure position of CAM 5 and provide a signal to the controller for determining proper control of the motor. Once in the unlocked position, the eye 9 attached to the handle 1 is released from interference by slider bolt 3 and handle 1 is capable of being lifted from housing 2 and optionally rotated.

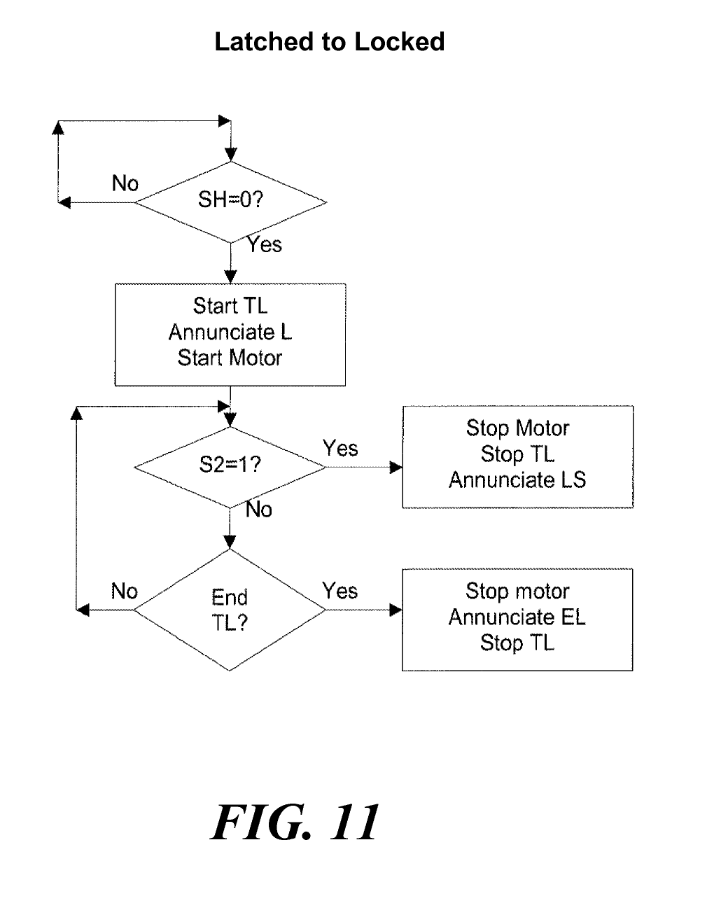

As shown in the flow chart of FIG. 11, the controller 7 senses the position of the handle 1, and after the handle 1 is unlocked and the user proceeds to lift (and optionally rotate) the handle 1 to unlatch the door from the cabinet, the controller 7 proceeds to energize the motor 6 to move the CAM 5 to the latched position shown in FIG. 7. In the latched position, the slider bolt 3 is biased to the position shown in FIG. 7 by one or more springs 4.

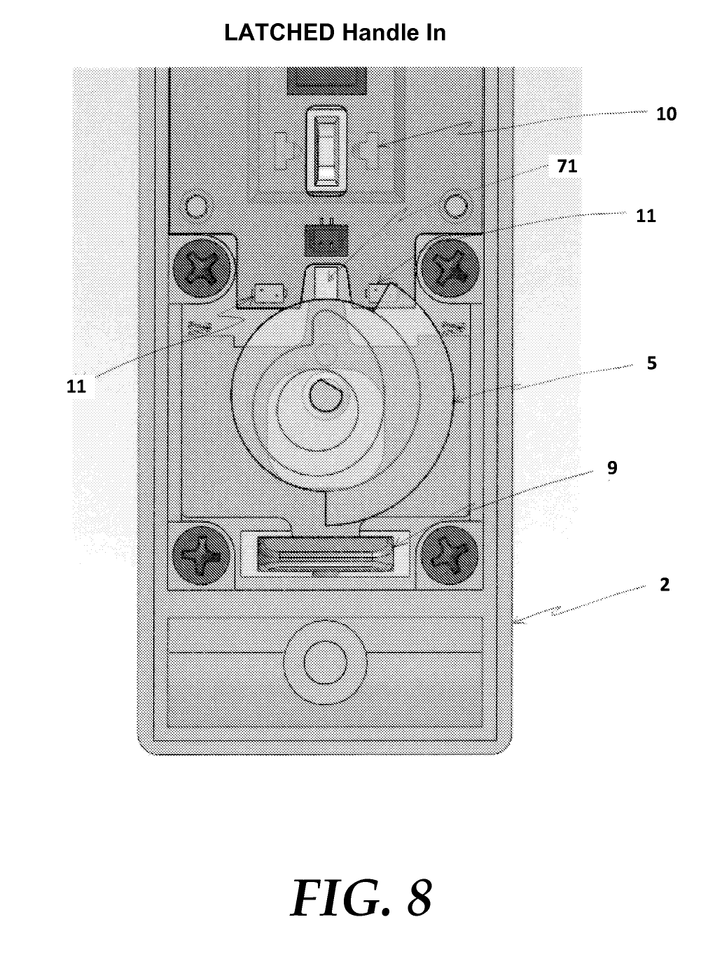

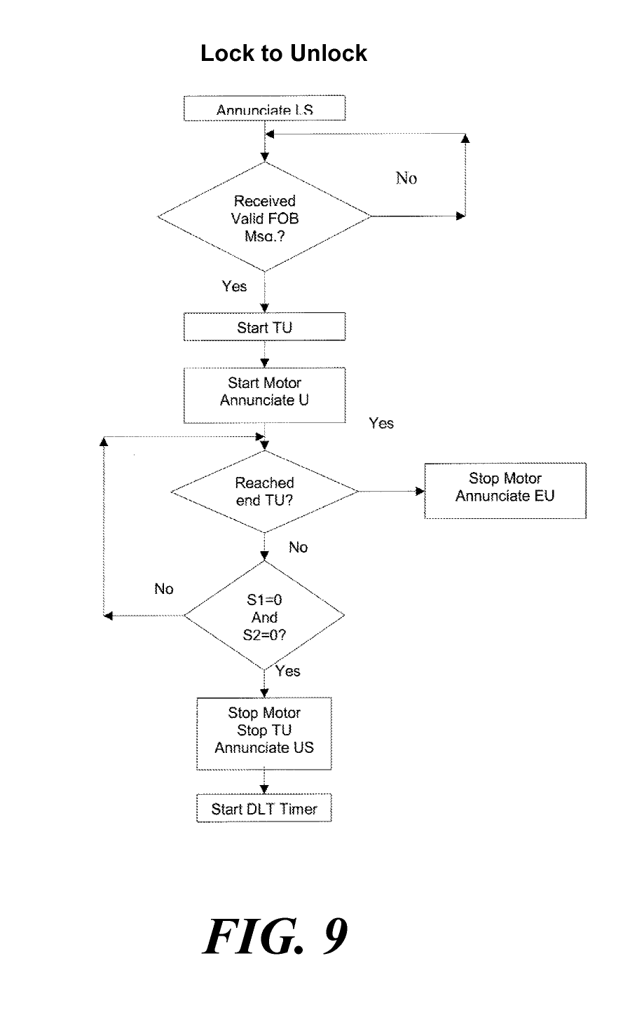

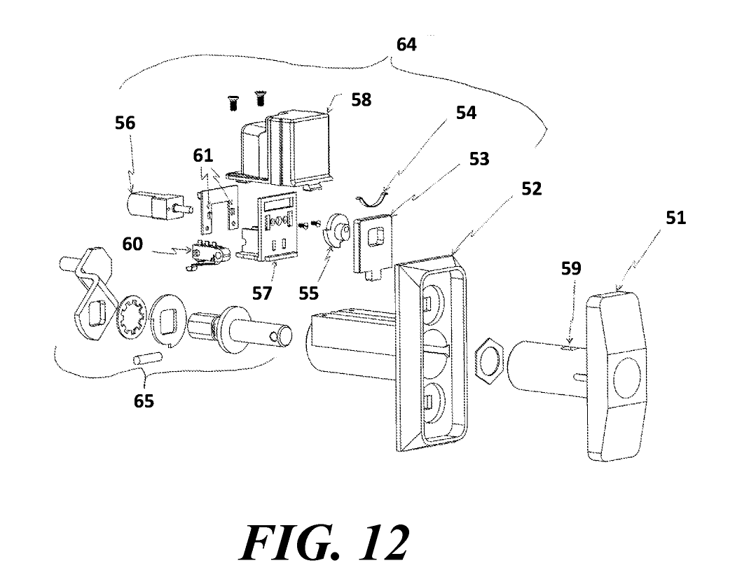

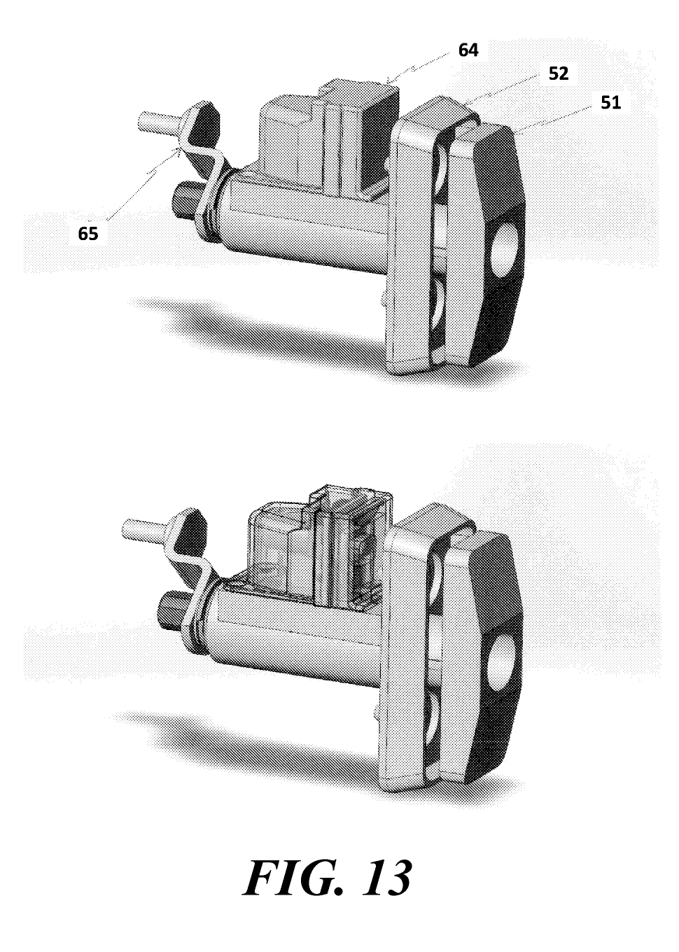

As described in the flowchart of FIG. 12, when the user is finished accessing the cabinet, the handle 1 is pushed into the housing 2, and the eye 9 pushes against the slider bolt 3; the slider bolt 3 is biased by the springs 4 so as to lift up and allow the eye 9 to pass by the slider bolt 3. Once the eye 9 passes the slider bolt 3, the springs 4 push the slider bolt 3 back to the latched position, capturing the eye 9. The controller 7 senses the handle 1 in the housing 2 via sensor 10, then first waits for the eye 9 to pass the slider bolt 3 as shown in FIG. 8 before proceeding to rotate the CAM 5 to the locked position shown in FIG. 5.

Referring still to FIG. 5, if the slider bolt 3 is manually lifted upward, the CAM 5 interferes at surface 14 to slide bolt pin 13 to maintain the slider bolt 3 in the locked position. With the CAM 5 interfering with the slider bolt pin 13, the unit is less vulnerable to a thief or vandal attempting to defeat the lock by using either a tool or a vibration force to move the slider bolt 3 upward against the weaker downward force of Springs 4.

As can be seen from the above, the disclosed electronic control lift-handle product is an effective solution that is able to be mounted to the door of a cabinet, and to secure the door in a manner that overcomes some of the problems found in prior systems. In addition to the electronic control lift-handle product, the novel electronic control t-handle product, while differently configured, is substantially as effective at providing a secure closure in a manner that overcomes problems in prior designs.

The electronic control t-handle product consists of a handle 51, a housing 52, latch hardware 65, a MCU 64 and CPU control electronics (not shown). The housing 52 is mounted to the door of a cabinet, and the latch hardware 65 is attached to a latch device that will operate to latch and unlatch the door to the cabinet. The MCU 64 attaches to the body of the housing 52, and the handle 51 resides inside of the housing 51. The MCU 64 is controlled by the CPU 65 to latch, lock and unlock the handle 51 within the housing 51. When the MCU 64 unlocks the handle 52, the handle pops-out of the housing 52 for the user to operate. The user operates the handle 51 by turning it ¼ turn (90 degrees) clock-wise to operate latch hardware 65. When finished, the user closes the cabinet door, turns the handle 51 ¼ turn in the counter-clockwise direction to re-latch the door to the cabinet. Lastly, the user pushes the handle 51 in so as to lock the handle 51 into the housing 52.

In the illustrated embodiment, the MCU 64 consists of a slider bolt 53, a spring 54, a CAM 55, a motor 56, a mount 57, a cover 58, a handle sensor 60, and one or more CAM sensors 61. The handle 51 seats in the housing 52 when the unit is in the latched or locked position, and is locked into the housing 52 by the slider bolt 53 protruding into handle slot 59 when the unit is latched or locked.

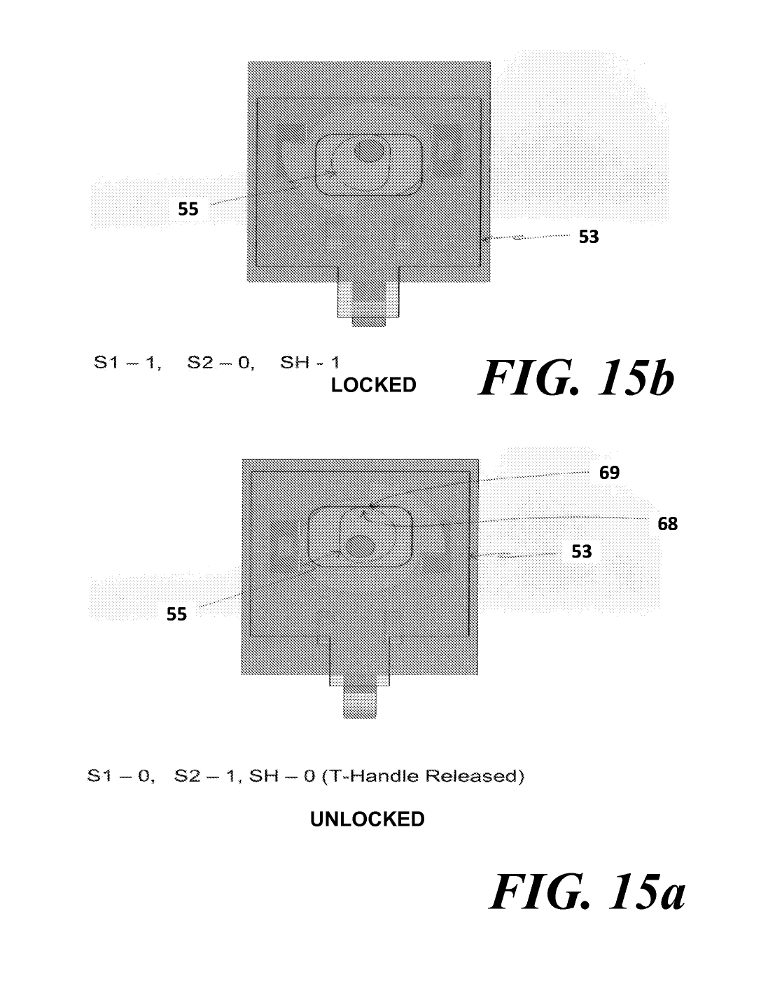

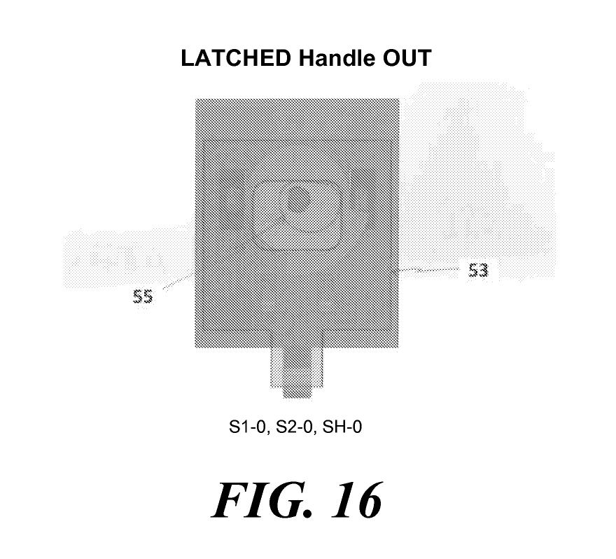

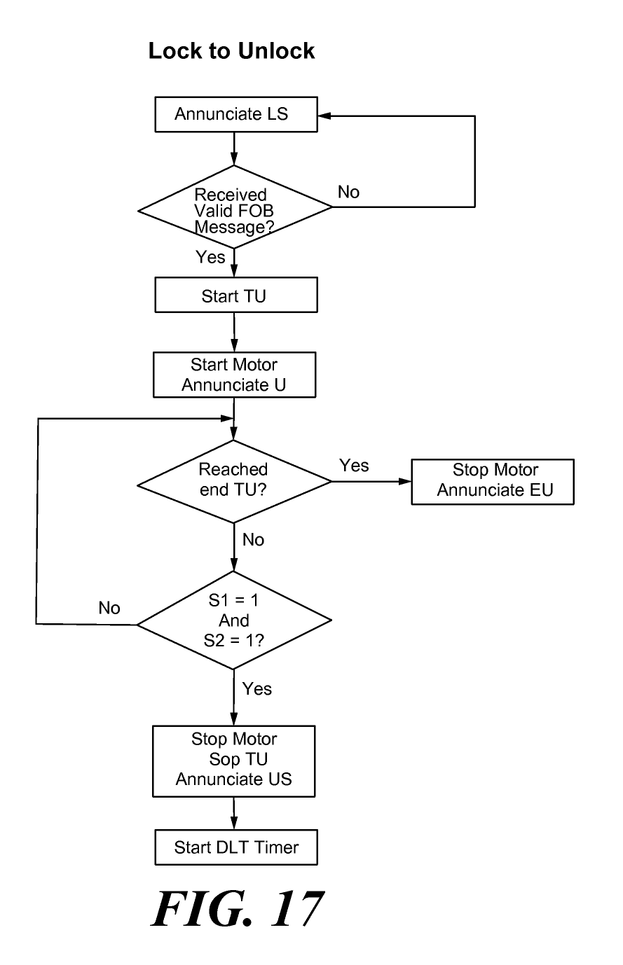

The motor 56 serves to rotate the CAM 55 through 360 degrees to change the state of the handle 51 from locked, to unlocked, to latched. The slider bolt 53 is biased to be latched in the downward position into slot 59 by spring 54 as shown in FIG. 17. The CAM 5 controls the slider bolt 53 by applying a force from surface 66 to the slider bolt 53 surface 67 if there is an attempt to push the bolt toward the upward unlocked position when the unit is locked as shown in FIGS. 15 and 16A. The CAM 5 further controls the slider bolt 53 by applying a force from surface 68 to the slider bolt along surface 69 when the motor 6 is rotated and when the unit is unlocked as shown in FIG. 16B.

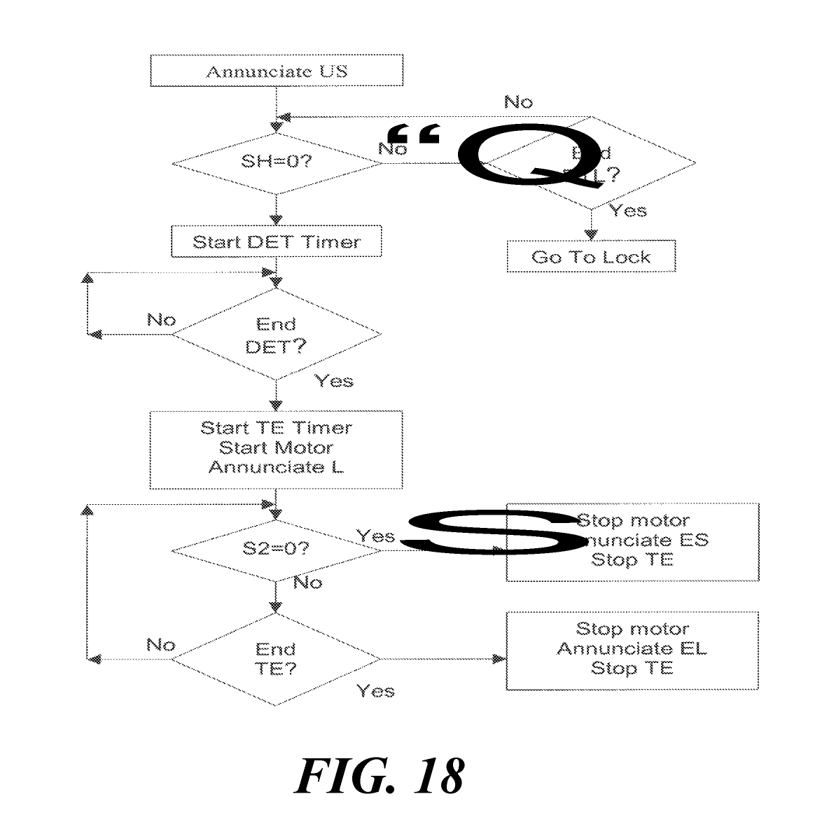

The electronic controller CPU controls Motor 56 to rotate CAM 55 to the three positions. The position CAM 55 is controlled to is sensed by two optical sensors 61 sensing the position of CAM 55. A handle position sensor 60 is also utilized. An IRDA infrared transceiver (not shown) is included for detecting an electronic key. The control of the unit is described in the flow charts of FIGS. 18, 19, and 20.

In the flow chart FIG. 18, the unit is initially locked as shown in FIG. 15. If the controller IRDA infrared transceiver detects the electronic key, the cam 55 is rotated and applies an upward force to the sliding bolt 53 along surface 69 to move the slider bolt 53 against the downward spring bias force and lift bolt 53 to the unlocked position as shown in FIG. 16B. The sensors 61 measure the position of the CAM 55 and provide a signal to the controller for determining proper control of the motor. Once the slider bolt 53 is in the unlocked position, the handle 51 is released from interference by the slider bolt 53 and is released from the housing 52 and rotated by the user.

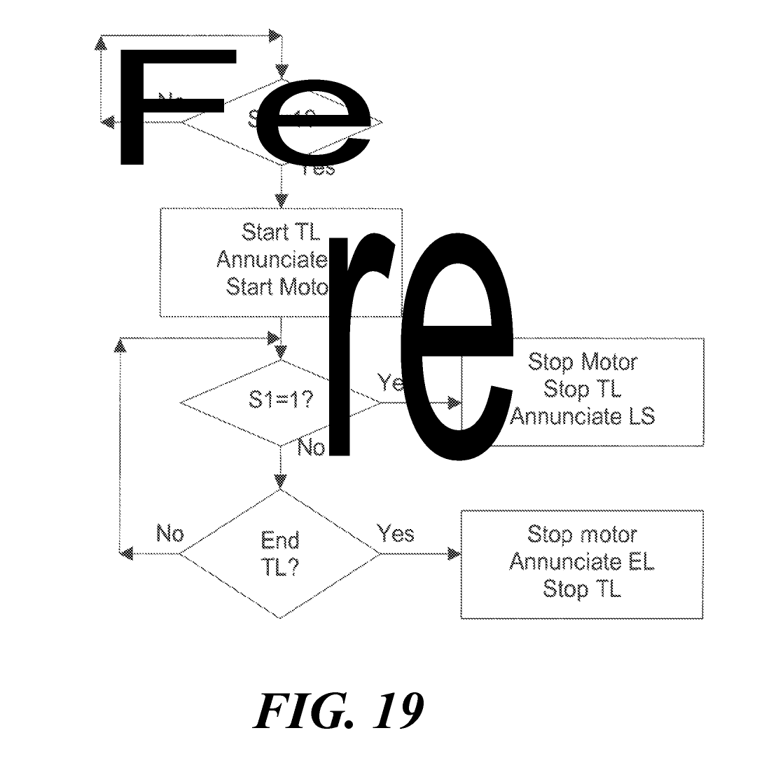

In the flow chart FIG. 19, the position switch 60 and the CPU controller sense the position of the handle 51, and after the handle 51 is unlocked and the user proceeds to rotate the handle 51 to unlatch the door from the cabinet, the controller proceeds to energize the motor 56 to move the CAM 55 to the latched position in FIG. 17. In the latched position, the slider bolt 3 is biased by the spring 54 to the position shown in FIG. 17.

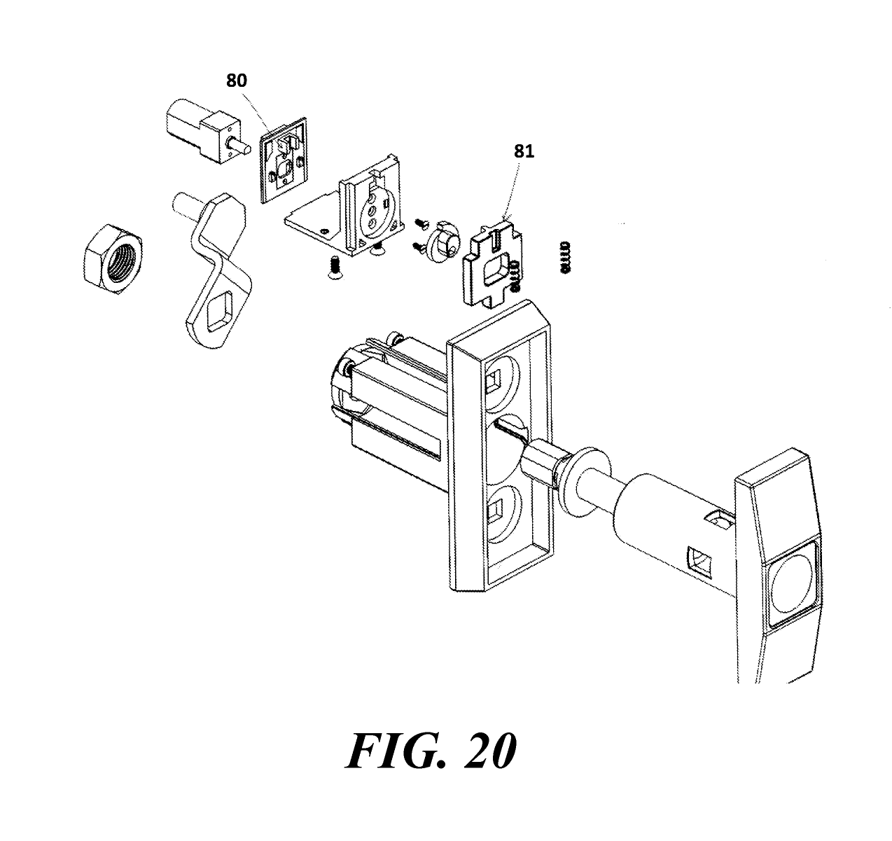

As described in the flowchart of FIG. 20, when the user is finished accessing the cabinet, the handle 51 is pushed into housing 52; when handle 51 surface pushes against the slider bolt 53, the slider bolt 53, being biased by spring 54, will lift upward to allow the handle 51 to protrude into the housing 52. Once the slot 59 passes the slider bolt 53, the spring 4 will push the slider bolt 53 back to the latched position to hold the handle 51 into the housing 52. The controller, sensing via sensor 60 that the handle 51 in the housing 52, will first wait for slot 59 to pass the slider bolt 53 as shown in FIG. 15 and will then rotate the CAM 55 to the locked position as shown in FIG. 16A.

In the configuration illustrated in FIG. 16A, the CAM 5 can apply a force at surface 66 to the slider bolt 53 at surface 67 to maintain the slider bolt 53 in the locked position in the event that the slider bolt 53 is pushed upward. Through the ability of the CAM 5 to hold the slider bolt 53 in the locked position, the unit is less vulnerable to a thief or vandal attempting to defeat the lock using a tool or a vibration force to move slider bolt 53 upward against the weaker downward force of spring 54.

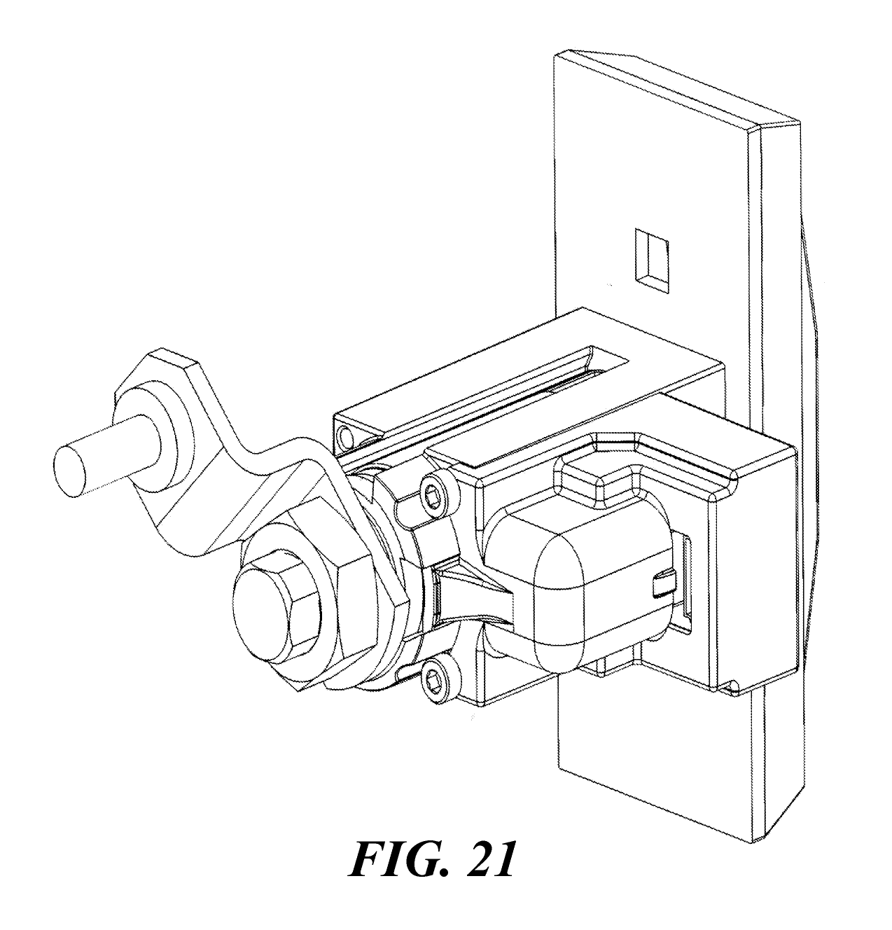

FIG. 21 is drawing of the MCU with a sensor 80 for detecting the slider bolt 81. By detecting the slider bolt, the controller can identify the position of the handle, whether it is unlocked and extended with the slider in the retracted position or locked and in the extended position. This sensor can be used in conjunction with or in place of handle detector switch 60.

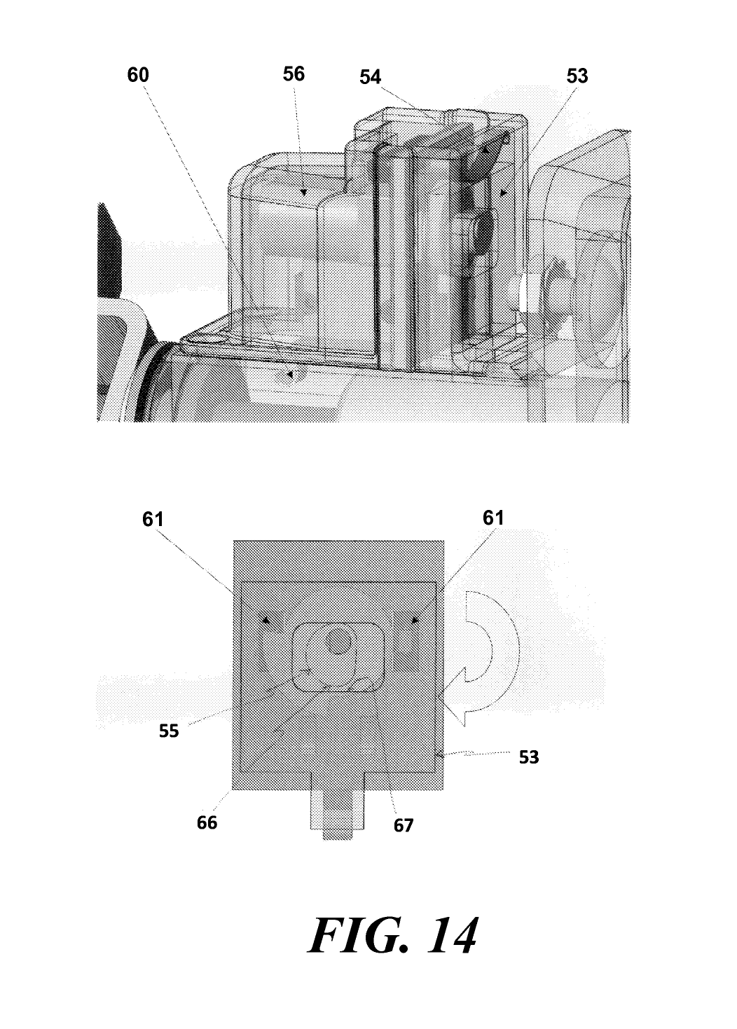

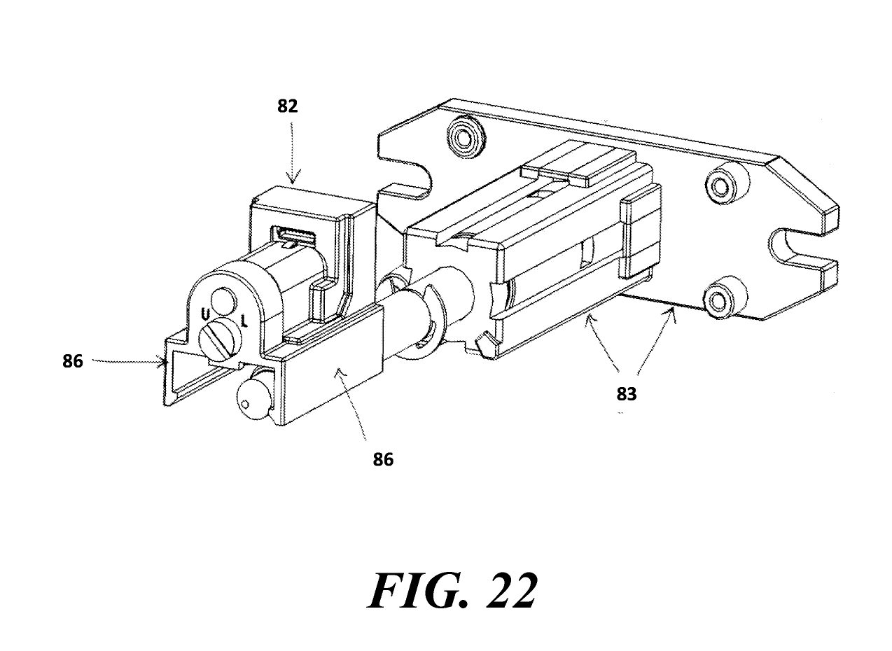

Similarly, the drawing of FIG. 22 shows an alternate optional mounting position of MCU on the t-handle housing at the 3:00 position. Alternate mounting positions will be useful in retrofit applications whereby a vending machine may have other accessories mounted around the T-handle, and the installer requires the flexibility of mounting the MCU at either the 12:00 (as in FIG. 14), 3:00 (FIG. 22), 6:00 or 9:00 positions, i.e., whichever position is unobstructed and allows the position of the MCU to not interfere with pre-existing accessory equipment in the machine.

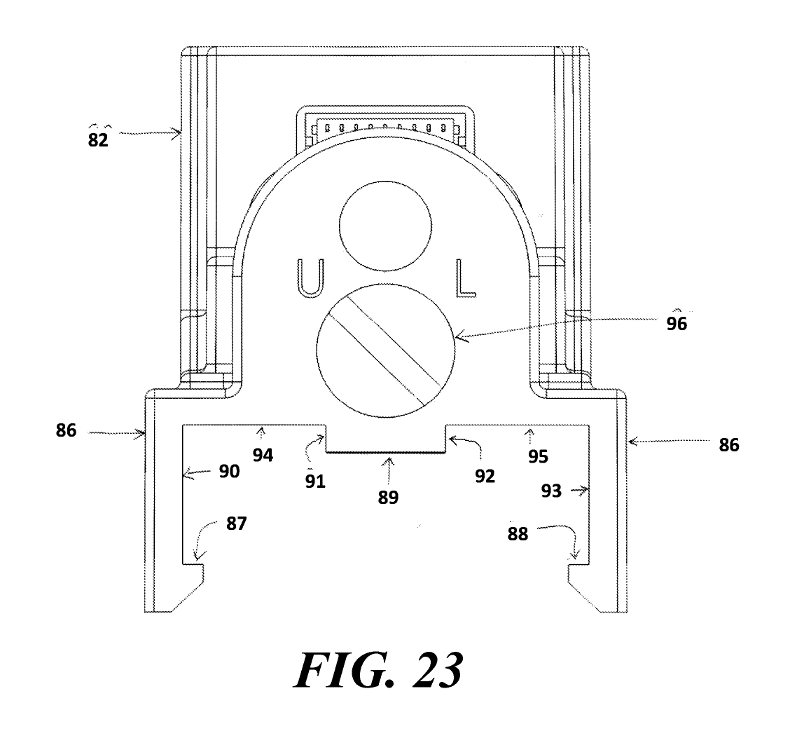

FIG. 23 shows an alternative design 82 of the MCU, whereby the MCU will mount to housing 83 which was pre-installed in vending machines. The pre-installed housing would normally house a standard t-handle and a lock plug/core operated by a mechanical key. In order to retrofit the invention to a vending machine and to avoid the labor and material to replace the existing housing, the pre-installed housing will remain in the machine. MCU 82 is similar to MCU 64 except for the way it slides onto and fastens to pre-existing housing 83.

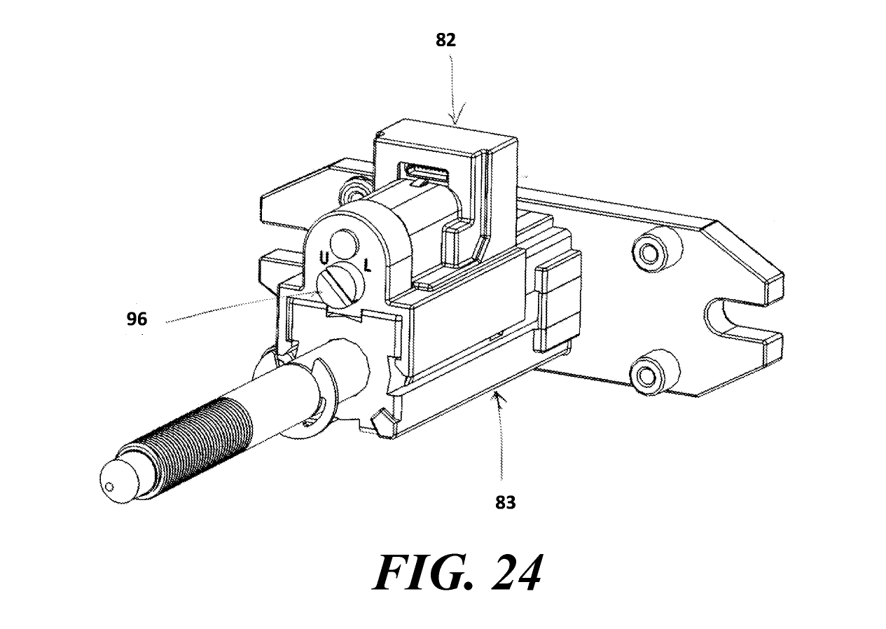

MCU 82 has legs 86 that will extend along the vertical surfaces of housing 83, and the rear view of MCU 82 in FIG. 24 shows the MCU surfaces that could potentially touch housing 83 during installation, such as horizontal edges 87, 88, 89, 94, 95 and vertical surfaces 90, 91, 92, and 93 that will capture housing 83 at least partially along multiple outer surfaces of housing 83. Fastener 96 is used to fasten the MCU to the housing once seated.

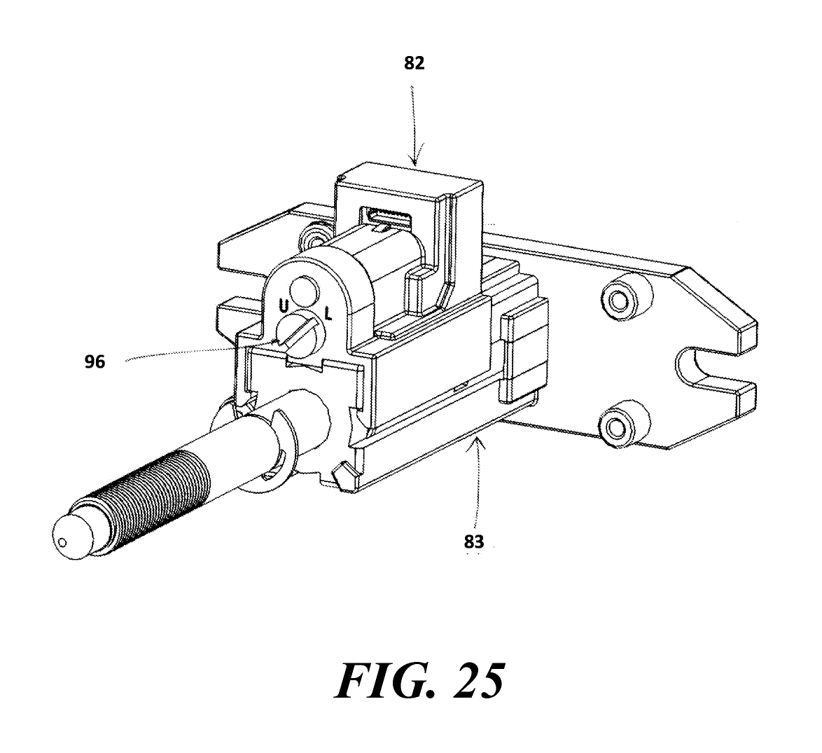

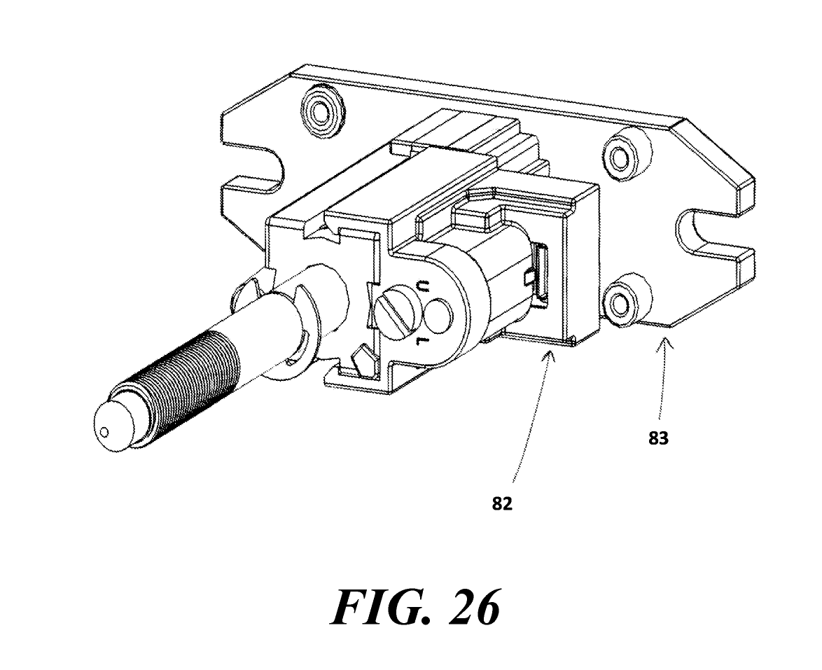

In this embodiment, the installer would apply the MCU 82 by sliding the MCU 82 on the pre-existing housing at for example the 12:00 position as shown in FIG. 25. MCU 82 slides on housing 83 and seats until the rear end of MCU 82 is flush with the rear end of housing 83and fastened by fastener 96 as shown in FIG. 26. Next, the installer would fasten the MCU to the housing by fastener 96 fastening the MCU to the housing. The fastener fastens MCU 82 with a tool at the rear of the housing, and/or the MCU can also be fastened by a fastener on the inside of the housing with a tool that travels inside the housing to reach the fastener.

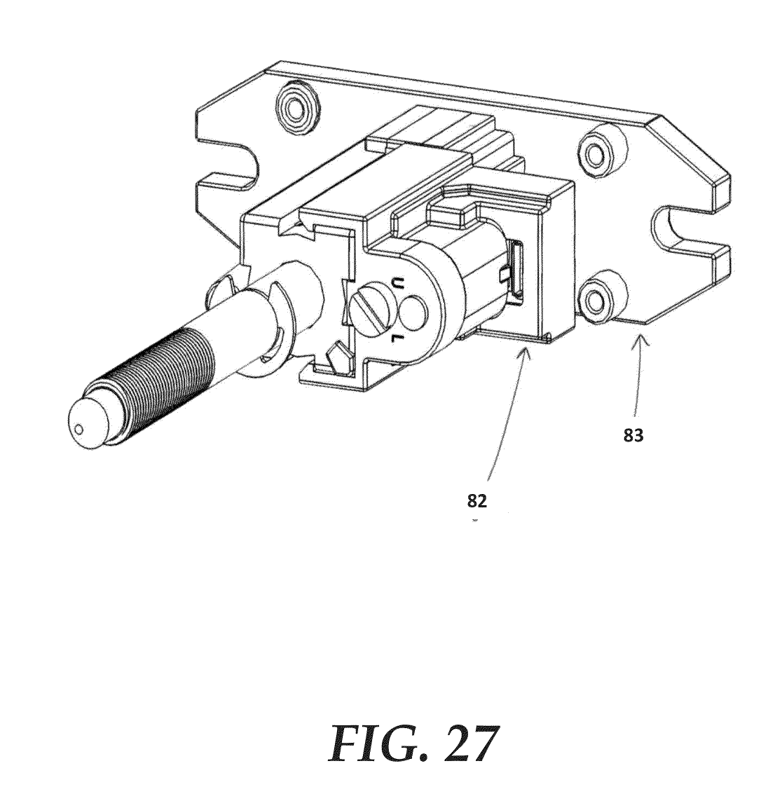

It will be appreciated that the MCU 82 can also be installed at the 3:00, 6:00 or 9:00 positions; position 3:00 is shown by way of example in FIG. 27. The fastener 96 can be operated by a tool inserted into the head of the fastener as shown in FIG. 24 as a flathead screw, or the Fastener head can be inside the MCU 82 and operated by inserting the tool into the front of the housing to operate the fastener head after the MCU is seated on the housing.

While only certain embodiments have been set forth, alternatives and modifications will be apparent from the above description to those skilled in the art. These and other alternatives are considered equivalents and within the spirit and scope of this disclosure and the appended claims.

What is claimed is:

1. An electronic control lift-handle product configured for mounting to a door of a cabinet to securely close the cabinet, the electronic control lift-handle product comprising:
a handle, a housing, a slider bolt, slider bolt pin, slider bolt guide, and one or more springs 4; and
a CAM, motor, circuit board controller, eye, handle sensor, one or more CAM sensors, and an IRDA infrared transceiver, configured such that the handle seats in the housing when the unit is in the latched or locked position, the motor serves to rotate the CAM by 360 degrees to change the state of handle from locked to unlocked to latched, and wherein the slider bolt seats in the housing and is biased downward to the latched position by the one or more springs, and wherein the CAM maintains the slider bolt in the locked position if there is an attempt to push the slider bolt up to the unlocked position when the unit is locked.

2. An electronic control T-handle product configured for mounting to a door of a cabinet to securely close the cabinet, the electronic control t-handle product comprising:
a handle, a housing, latch hardware, a MCU and CPU control electronics, the handle residing inside of the housing, the MCU being controlled by the CPU to latch, lock and unlock the handle within the housing;
wherein the MCU consists of a slider bolt, a spring, a CAM, a motor, a mount, a cover, a handle sensor, and one or more CAM sensors;
and wherein the handle is locked into the housing by the slider bolt protruding into a handle slot when the unit is latched or locked, the motor serves to rotate the CAM through 360 degrees to change the state of the handle from locked, to unlocked, to latched, and wherein the CAM controls the slider bolt to maintain a locked position if there is an attempt to push the bolt toward the upward unlocked position when the unit is locked.
